(19) United States
(12) Patent Application Publication
(10) Pub. No.: US 2003/0020479 A1
(43) Pub. Date: Jan. 30, 2003

(54) Electrical rechargeable battery with an electronic circuit integrated in the rechargeable battery container

(75) Inventors: Ingo Koch, Hameln (DE); Martin Schreiber, Hohenhameln (DE)

Correspondence Address: SCHNADER HARRISON SEGAL & LEWIS, LLP, 1600 MARKET STREET, SUITE 3600, PHILADELPHIA, PA, 19103

(73) Assignee: VB Autobatterie GmbH, Hannover (DE)

(21) Appl. No.: 10/198,270

(22) Filed: Jul. 17, 2002

(30) Foreign Application Priority Data
Jul. 18, 2001 (DE) 101 35 067.8

(51) Int. Cl. G01N 27/416; H02J 7/16

(52) U.S. Cl. 324/431

(57) ABSTRACT

An electrical rechargeable battery with an electronic functional monitoring circuit integrated in the rechargeable battery container. The rechargeable battery contains an apparatus for measuring battery voltage, an apparatus for measuring battery temperature and an apparatus which detects the current direction by means of a measurement apparatus on the battery pole stem. The electronic circuit contains a microprocessor which uses the input variables to calculate the state of charge and/or the serviceability of the rechargeable battery, and the calculated output values can be passed on via a communication apparatus. A visual indicator is arranged on the rechargeable battery container, can be actuated via the communication apparatus, and indicates information about the state of charge and/or serviceability.

### RELATED APPLICATION

This application claims priority of DE 101 35 067.8, filed Jul. 18, 2001.

### FIELD OF THE INVENTION

This invention relates to an electrical rechargeable battery with an electronic functional monitoring circuit integrated in the rechargeable battery container.

### BACKGROUND

Discharged rechargeable batteries, or rechargeable batteries which cannot be used anymore, are one of the main reasons for motor vehicle breakdowns. There is, therefore, a need for a rechargeable battery which carries out self-monitoring and provides a warning in good time when it predicts that it will no longer be able to satisfy the requirements in the vehicle. In comparison to electronics provided in the vehicle itself, implementation of such monitoring directly on the rechargeable battery has the advantage that it is available to anyone, irrespective of the vehicle manufacturer and vehicle age.

Rechargeable batteries are known which have integrated voltage measurement for monitoring the battery state. By way of example, DE 198 34 740 A1 describes a method for battery monitoring using an integrated electronic monitoring device with battery temperature measurement, outside temperature measurement, time recording and storage or memory apparatuses.

DE 44 06 193 A1 discloses a rechargeable battery which, for functional monitoring purposes, contains an acoustic signal transmitter which can be actuated by a measurement apparatus which records a state value of the rechargeable battery. The signal transmitter and measurement apparatus are arranged in a common housing, which can be plugged onto the rechargeable battery.

DE 333 1360 discloses a rechargeable battery which contains an electronic functional monitoring module integrated into the housing wall or housing cover and is, in particular, an electronic clock.

It would accordingly be advantageous to specify a rechargeable battery which has an electronic functional monitoring circuit integrated into the rechargeable battery container and be suitable for determining the state of charge and/or the serviceability of the rechargeable battery.

### SUMMARY OF THE INVENTION

The invention relates to an electrical rechargeable battery including a container, at least one electrode having at least one pole stem positioned in the container, an electronic monitoring circuit integrated into the container, a voltage detector connected to the circuit, a temperature sensor located in the container and connected to the circuit, a current direction detector connected to the at least one pole stem and the circuit, and a display/communication device connected to the circuit to display/communicate at least one output value determined from input variables received from at least one of the voltage detector, temperature sensor or current direction detector regarding state of charge and/or serviceability of the battery.

### BRIEF DESCRIPTION OF THE DRAWINGS

The subject matter of the invention will be explained in more detail in the following text with reference to FIGS. 1-4.

FIG. 1 shows, schematically, the design of a 12 V rechargeable battery according to the aspects of the invention.

FIG. 2 shows a section through a rechargeable battery equipped according to the invention.

FIG. 3 shows the battery of FIG. 1 connected to a plug-in apparatus having an indicator according to additional aspects of the invention.

FIG. 4 shows the battery of FIG. 1 connected to additional auxiliary apparatus in accordance with aspects of the invention.

### DETAILED DESCRIPTION

It will be appreciated that the following description is intended to refer to specific embodiments of the invention selected for illustration in the drawings and is not intended to define or limit the invention, other than in the appended claims.

According to the invention, information about the battery current is used to produce a better statement about the rechargeable battery state than is possible just by a voltage measurement. In this case and in particular, information about changes in the current direction is itself sufficient. Appropriate algorithms for battery state identification are described, by way of example, in German Patent Application 100 49 495.1.

In the case of the rechargeable battery according to the invention, these algorithms are carried out on the battery itself, separately from the vehicle, and the results are reported to the vehicle operator.

In comparison to a commercially available battery, the apparatus for battery monitoring according to the invention utilizes only changes in the cover, so that the influence on battery behavior and on production costs are kept low.

Turning now to the drawings, the voltage of the rechargeable battery 1 is measured between the two battery poles 3a, 3b, the temperature is measured via a probe 4 outside the electrolyte area, to prevent corrosion to the measurement sensor, and prevent acid from emerging through the cable bushing. Furthermore, a microcontroller 2 is provided, which interprets the measured values and uses them to make a statement about the battery state. A communication interface is provided to inform the driver of the state of the battery at any given time. One advantage of the invention is that no sensors are arranged in the electrolyte, so that the influence on the electrical characteristics of the battery is negligible.

According to the invention, an apparatus for monitoring the current direction is integrated in the rechargeable battery. It is thus possible to assess the operating states at any given time, such as the battery voltage and the battery temperature, separately, after discharging and charging. According to the invention, a section 5 of the pole stem is used for this purpose, on which the voltage drop is measured, with the change in the mathematical sign of the voltage difference being used as a signal for the change in the mathematical sign of the current. This voltage difference can likewise also be used to estimate the current that is flowing, particularly in the case of high currents.

A further possible way to identify the current direction can be implemented by monitoring the magnetic field on a current-carrying conductor of the rechargeable battery. The magnetic field has a different mathematical sign, depending on the current direction. Magnetic field sensors can be used to measure the magnetic field and detect the current direction. Installation of a Hall switch results in a signal being triggered directly in the event of a change in the magnetic field mathematical sign or in the current direction. An appropriate sensor or switch is preferably arranged directly on the pole stem, and is integrated in the cover.

The statements determined relating to the state of charge and to the performance of the battery are reported to the vehicle operator via a communication apparatus.

This may be an indicator 6 on the battery, which is provided with a liquid crystal display, LEDs or the like. It is also possible to use radio transmission, which transmits the signals to an indication apparatus, for the signals to be transmitted via a data bus, or for transmission to take place via an ultrasound transmitter, whose signal contains the information about the battery state and is received and indicated by an external indication apparatus.

It is also within the scope of the invention to provide for transmission via a transponder unit, with the transponder base station being integrated with an interrogation antenna in the indication apparatus which indicates the information about the state of charge or serviceability, or it is possible for transmission to take place via the power cable via the positive pole and negative pole of the rechargeable battery, with the indication apparatus which indicates the information about the state of charge or serviceability being supplied with power and data by means of a plug-in apparatus via the cigarette lighter in the motor vehicle.

It is also possible to provide for the information about the state of charge or serviceability to be reported to the vehicle operator by means of an acoustic signal, for example, by means of tone sequences at different speeds.

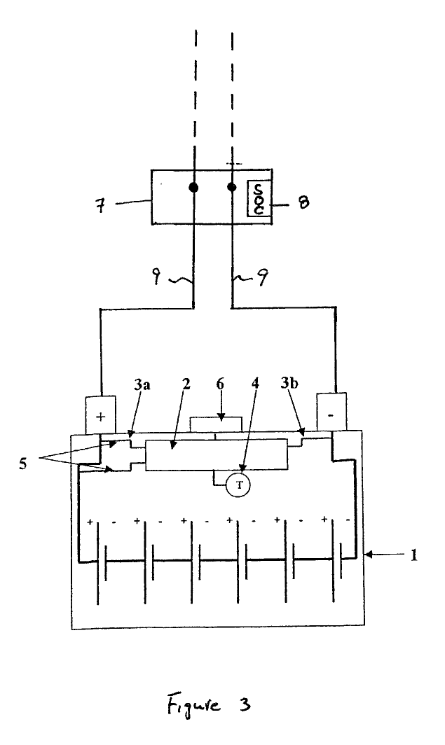

FIG. 2 shows selected measurement apparatuses according to the invention in a conventional battery fitting. All the additional parts associated with the invention are integrated in the cover, without needing to make any changes to the pole stem or to other battery parts.

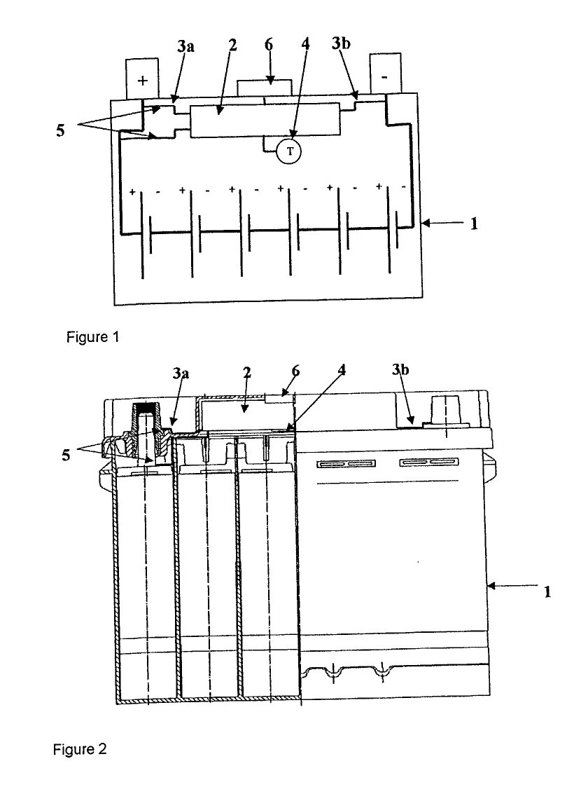

FIG. 3 shows a rechargeable battery of the type shown in FIG. 1 connected to a plug-in apparatus 7 containing a state of charge indicator 8 by way of suitable connecting wires 9.

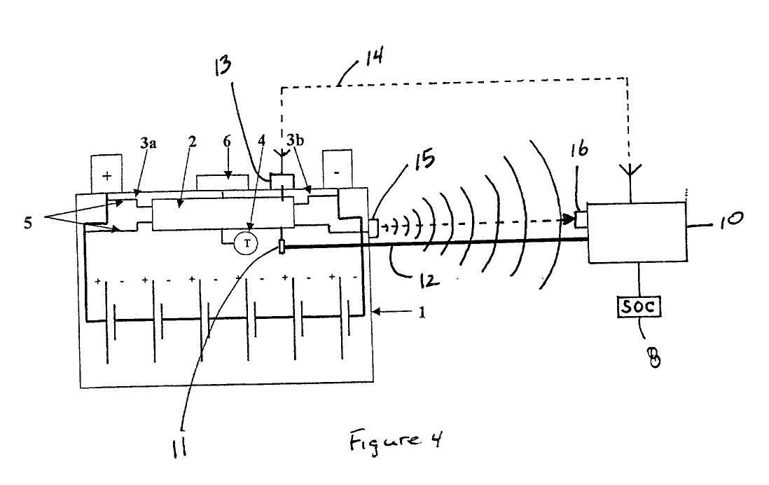

Similarly, FIG. 4 shows a battery of the type shown in FIG. 1 containing additional, auxiliary apparatus. For example, an indication apparatus 10 connects to a data bus interface 11 by way of data bus 12. Data bus interface 11, in turn, connects to microcontroller 2. A radio transmitter 13 also connects to microcontroller 2, which is capable of sending a signal, as indicated by the dotted lines 14, to a receiver on the indication apparatus. Finally, an ultrasound transmitter 15 connects to microcontroller 2 and emits ultrasound which is detectable by ultrasound receiver 16, which is also attached to indication apparatus 10 in this embodiment. Of course, other arrangements of the above auxiliary apparatus are contemplated and fully within the scope of this invention.

1. An electrical rechargeable battery comprising:
a container;
an electronic functional monitoring circuit integrated with the container;
an apparatus for measuring voltage of the rechargeable battery connected to the circuit as a first input variable;
an apparatus for measuring temperature in the rechargeable battery connected to the circuit as a second input variable; and
an apparatus which detects current direction with a measurement apparatus on a battery pole stem connected to the circuit as a third input variable;
wherein the electronic circuit contains a microprocessor which uses said input variables to calculate the state of charge and/or serviceability of the rechargeable battery, and calculated output values are transmitted via a communication apparatus.

2. The electrical rechargeable battery according to claim 1, wherein the apparatus for detecting current direction detects current direction with a tap for a voltage element on the pole stem.

3. The electrical rechargeable battery according to claim 1, wherein the apparatus for detecting the current direction detects current direction with a magnetic field produced by current flow through the pole stem.

4. The electrical rechargeable battery according to claim 1, wherein a visual indicator is arranged on the rechargeable battery container, which can be actuated via the communication apparatus and indicates information about the state of charge and/or the serviceability of the battery.

5. The electrical rechargeable battery according to claim 1, wherein the communication apparatus is a radio transmitter, which transmits output values to an externally arranged indication apparatus equipped with an apparatus for receiving a signal corresponding to the output values, and in that this indication apparatus indicates the information about the state of charge or the serviceability of the battery.

6. The electrical rechargeable battery according to claim 1, wherein the communication apparatus is a data bus interface, which emits output values to a data bus connected thereto.

7. The electrical rechargeable battery according to claim 1, wherein the communication apparatus is an ultrasound transmitter.

8. The electrical rechargeable battery according to claim 5, wherein the communication apparatus emits output values of an algorithm via a power cable via positive pole and negative poles of the rechargeable battery, and the indication apparatus has a plug-in apparatus supplied with power and data via an electrical connection in a motor vehicle.

9. An electrical rechargeable battery comprising:
a container;
at least one electrode having at least one pole stem positioned in the container;
an electronic monitoring circuit integrated into the container;
a voltage detector connected to the circuit;
a temperature sensor located in the container and connected to the circuit;
a current direction detector connected to the at least one pole stem and the circuit; and
a display/communication device connected to the circuit to display and/or communicate at least one output value determined from input variables received from at least one of the voltage detector, temperature sensor or current direction detector.

10. The electrical rechargeable battery according to claim 9, wherein the current direction detector detects current direction with a tap for a voltage element on the pole stem.

11. The electrical rechargeable battery according to claim 9, wherein the current direction detector detects current direction with a magnetic field produced by current flow through the pole stem.

12. The electrical rechargeable battery according to claim 9, wherein the display/communication device comprises a visual indicator arranged on the rechargeable battery container and indicates information about the state of charge and/or the serviceability of the battery.

13. The electrical rechargeable battery according to claim 9, wherein the display/communication device is a radio transmitter, which transmits output values to an externally arranged indication apparatus equipped with an apparatus for receiving a signal corresponding to the at least one output value, and provides information about the state of charge or the serviceability of the battery.

14. The electrical rechargeable battery according to claim 9, wherein the display/communication device comprises a data bus interface, which emits output values to a data bus connected thereto.

15. The electrical rechargeable battery according to claim 9, wherein the display/communication device comprises an ultrasound transmitter.

16. The electrical rechargeable battery according to claim 13, wherein the display/communication device emits output values of an algorithm via a power cable via positive pole and negative poles of the rechargeable battery, and the indication apparatus has a plug-in apparatus supplied with power and data via an electrical connection in a motor vehicle.
